(19) United States
(12) Patent Application Publication
(10) Pub. No.: US 2026/0115703 A1
(43) Pub. Date: Apr. 30, 2026

(54) PREPARATION OF MODIFIED ZEOLITE CATALYST, AND MODIFIED ZEOLITE CATALYST AND GAS PURIFICATION METHOD USING SAME

(71) Applicant: UNIVERSITY OF SCIENCE AND TECHNOLOGY BEIJING, Beijing (CN)

(72) Inventors: Ziyi LI, Beijing (CN); Shao ZHANG, Beijing (CN); Zixuan SHI, Beijing (CN)

(21) Appl. No.: 19/375,735

(22) Filed: Oct. 31, 2025

Related U.S. Application Data
(63) Continuation of application No. PCT/CN2023/128297, filed on Oct. 31, 2023.

(30) Foreign Application Priority Data
Aug. 14, 2023 (CN) 202311019990.9

(51) Int. Cl. B01J 29/06; B01J 37/04; B01J 37/08; B01J 37/34; C01B 13/10

(52) U.S. Cl. CPC B01J 29/06; B01J 37/04; B01J 37/082; B01J 37/346; C01B 13/10; C01B 2210/0018

(57) ABSTRACT

Provided are the preparation of a modified zeolite catalyst, a modified zeolite catalyst and the gas purification method using the same. The preparation is implemented by using a method comprising: mixing a metal salt solution with zeolite to form a non-Newtonian fluid mixture, drying the mixture using microwaves, and finally calcining same, so as to obtain a zeolite catalyst. In the preparation method, microwaves are used to dry the mixture of the metal salt solution and the zeolite, the drying time is short, and the evaporation of water is quick, thereby maintaining the state of metal cations in a zeolite framework, and preventing catalyst particles (metal clusters) from being deintercalated from the zeolite framework and becoming aggregated. The modified zeolite catalyst prepared by using the preparation method contains metal clusters which are uniformly dispersed, and comprises an active component composed of a plurality of metal cations.

### CROSS-REFERENCE TO RELATED APPLICATIONS

This application is a continuation of International Patent Application PCT/CN2023/128297, filed on Oct. 31, 2023, which claims priority to China Patent Application 202311019990.9, filed Aug. 14, 2023. International Patent Application PCT/CN2023/128297 and China Patent Application 202311019990.9 are incorporated herein by reference.

### FIELD OF THE INVENTION

The present disclosure belongs to the field of modified zeolite preparation, and in particular relates to preparation of a modified zeolite catalyst, and a modified zeolite catalyst and a gas purification method using the same.

### BACKGROUND OF THE INVENTION

In industrial production and daily life, a large amount of gas pollutants is produced, and these waste gases cause serious harm to human health and the climatic environment. For example, volatile organic compounds (VOCs) in the air can undergo a series of chemical reactions when exposed to sunlight, and ozone generated will lead to global warming, affect air quality and the ecosystem of the earth, and endanger human health. Nitrogen-containing waste gases produced in chemical production process not only affect the surrounding environment and human health, but also destroys the ozone layer. If sulfur-containing pollutants emitted during the production of fossil energy such as petroleum are discharged into the atmosphere in a gaseous form (such as gaseous sulfur dioxide, hydrogen sulfide, etc.), they are likely to cause natural disasters such as acid rain.

Common catalytic purification materials for gases include activated carbon, noble metal supported catalysts, transition metal oxides, and zeolite molecular sieves. The activated carbon is low in cost and readily available, but it has potential safety hazards of combustion and explosion and its structure is easily eroded after long-term use; the noble metal supported catalysts have high purification efficiency, but they are expensive; the transition metal oxides are cheap and have high activity under dry conditions, but there is a problem of catalytic site deactivation under long-term operation conditions. Zeolite is a typical microporous inorganic material, is composed of AlO₄ and SiO₄ tetrahedra, has micro-mesoporous pore channels and sufficient catalytic active sites, is gradually regarded as a suitable material for gas catalytic purification and has attracted widespread attention.

Unlike the transition metal oxides, gases adsorbed on zeolites with a high specific surface area (up to 800 m²/g), a large pore volume, and special acidic sites are subjected to a process including both physical adsorption in pore channels and catalytic decomposition at Lewis acid sites (LASs). The interaction between gas molecules and the LASs is promoted by the small pore sizes similar to the size of the gas molecules in the zeolite, and according to the adsorption theory, this effect is more pronounced at lower temperatures. Research has found that the content and dispersion degree of the LAS are related to a framework structure, a silica-alumina ratio, a cation type and an ion exchange mode of the zeolite, wherein the type and distribution of metal cations are the main factors affecting catalytic activity. Therefore, the selectivity and conversion efficiency can be regulated to a large extent by ionically modifying the zeolite, and controlling the state of cations at exchange sites of the zeolite.

A salt solution stirring impregnation method is a traditional liquid-phase zeolite modification method. A zeolite is impregnated in a prepared metal salt solution, ion exchange is promoted by heating, stirring, etc., followed by repeated washing with deionized water, and drying and calcining are performed to obtain a modified zeolite powder. This technique has the following disadvantages: (1) the modification process is complicated, a large amount of waste liquid is generated, it is easy to cause environmental pollution, and the technique is not suitable for industrial application; (2) the degree of ion exchange is low, it is difficult to ensure the content of a catalytic active component, and metal present in the framework of the modified zeolite exists as a single ion, and the catalytic activity is low; and (3) slow evaporation of water vapor during drying causes metal ions to detach from the zeolite framework with water molecules and agglomerate on the surface of the zeolite.

In addition, in the prior art, conventional gas purification catalysts have low catalytic activity at low temperatures, are prone to irreversible deactivation under long-term use conditions, and exhibit poor regeneration performance. Furthermore, existing modified zeolites have a low metal ion exchange rate, and a single metal ion is used as the active component, so the catalytic activity is low. At present, there is no zeolite catalyst with uniform and highly dispersed metal clusters.

### SUMMARY OF THE INVENTION

In order to solve the above problems, the present disclosure proposes preparation of a modified zeolite catalyst, a modified zeolite catalyst and a gas purification method using the same. The zeolite catalyst prepared by using the preparation method has a plurality of clusters composed of metal cations as catalytic active components, the clusters being uniformly distributed. The metal clusters of the zeolite catalyst exhibit high catalytic activity, play a crucial role in catalytic decomposition, and improve the low-temperature catalytic oxidation efficiency of the catalyst.

The present disclosure is achieved by the following technical solutions:

In a first aspect of the present disclosure, provided is a preparation method for a modified zeolite catalyst, wherein the preparation method adjusts metal clusters in a framework of a modified zeolite, and includes mixing a metal salt solution with a zeolite to form a non-Newtonian fluid mixture, drying the mixture by using microwaves, and finally performing calcining to obtain the modified zeolite catalyst.

Further, the preparation method specifically comprises the steps of:
separately preparing the metal salt solution and the zeolite in a specified ratio;
preparing the non-Newtonian fluid mixture: mixing and stirring the metal salt solution and the zeolite to obtain the non-Newtonian fluid mixture;
microwave drying the non-Newtonian fluid mixture; and
calcining the dried non-Newtonian fluid mixture to obtain the modified zeolite catalyst.

Further, preparing the metal salt solution specifically comprises:
determining the amount of a metal salt used: calculating a mass of the metal salt based on a silica-alumina ratio and a theoretical degree of ion exchange;
determining the amount of water required to prepare the metal salt solution: adding deionized water dropwise to an equivalent amount of the zeolite, and performing uniform stirring until the obtained mixture is in a non-Newtonian fluid state, the amount of the water added being the amount of the water required to prepare the metal salt solution; and
mixing the metal salt with the required amount of water to obtain the metal salt solution.

Further, a molar ratio of the metal salt to the zeolite is in the range of greater than 0 to 5.

Further, the metal salt comprises nitrate and/or acetate.

Further, the metal clusters include one or more metal clusters of Mn²⁺, Mn₂O²⁺, Mn₃O₃²⁺, [AlO₂]⁺, [MnCuO]²⁺, [Mn₂CuO₃]²⁺, and [FeCoO]²⁺.

Further, microwave drying the non-Newtonian fluid mixture specifically comprises:
evenly spreading the mixture into a crucible or an evaporating dish or a stainless steel beaker, and then rapidly heating the non-Newtonian fluid mixture with a microwave reactor at a power of 100-1000 W for 30 s-30 min. Water in the mixture is rapidly evaporated during microwave heating, and a polymer of metal salt ions is locked in the pore channels of the zeolite to prevent the polymer from adhering to the surface of the zeolite due to evaporation of the water; and at this time, at least one initial cluster is uniformly distributed in the pore channels of the zeolite powder, the initial cluster comprising a metal ion and a nitrate ion.

In a second aspect, the present disclosure provides a modified zeolite catalyst, prepared by the preparation method for the modified zeolite catalyst described above, wherein a plurality of metal clusters are uniformly distributed in pore channels of a zeolite powder in the zeolite catalyst; and the metal clusters comprise metal ions and adapted oxygen atoms; and
at least one metal ion is present; and preferably, the number of the metal ions is 1-5.

In a third aspect of the present disclosure, provided is a gas purification method, using the modified zeolite catalyst described above to purify ozone. The zeolite catalyst removes ozone at a space velocity of 1×10⁴ h⁻¹-2×10⁶ h⁻¹ at −10° C. to 300° C., and maintains an O₃ removal rate of 90% or more for 2000 minutes.

Further, the zeolite catalyst maintains an O₃ removal rate of 90% or more for 2000 minutes at room temperature and a flow rate of 1.0 L·min⁻¹.

Further, the range of ozone purification comprises low-temperature and high-flow-rate aircraft cabin ozone removal, factory ozone exhaust treatment, and indoor ozone purification.

Further, the form of the zeolite catalyst comprises, but is not limited to, a powder catalyst, a granular catalyst (prepared after mixing with a binder), and a monolithic catalyst (extruded or coated).

The preparation method for the modified zeolite catalyst provided in the first aspect of the present disclosure comprises mixing the metal salt solution with the zeolite to form the non-Newtonian fluid mixture, drying the mixture by using microwaves, and finally performing calcining to obtain the modified zeolite catalyst. The preparation method adjusts the metal clusters in the framework of the modified zeolite, the amount of the metal salt used is calculated based on the silica-alumina ratio and the theoretical degree of ion exchange, and the amount of water used in the metal salt solution is calculated based on the target exchange state, so that a polymer formed by a metal cation and a water molecule is uniformly distributed in the pore channels of the zeolite, and the degree of metal ion exchange can be adjusted and controlled. In the preparation method, the microwaves are used to dry the mixture of the metal salt solution and the zeolite, the drying time is short, and the evaporation of water is quick, thereby maintaining the state of metal cations in a zeolite framework, and preventing catalyst particles (metal clusters) from being deintercalated from the zeolite framework and becoming aggregated. In addition, the preparation method adopts a simple process of mixing and stirring, avoiding a long-term heating and stirring process. The catalyst preparation time is greatly reduced, thereby reducing the energy consumption of the catalyst preparation process.

According to the modified zeolite catalyst provided in the second aspect of the present disclosure, the zeolite catalyst has a plurality of clusters composed of metal cations as catalytic active components, the clusters being uniformly distributed. Compared with the traditional modified zeolite catalyst with single cation exchange, the metal clusters of the zeolite catalyst exhibit higher catalytic activity, play a crucial role in the catalytic decomposition process of ozone (O₃), and improve the low-temperature O₃ catalytic oxidation efficiency of the catalyst. The zeolite catalyst has excellent low-temperature catalytic activity and stability and can maintain an O₃ removal rate of 90% or more for 2000 minutes at room temperature and a flow rate of 1.0 L·min⁻¹. In addition, the catalyst has excellent regeneration properties, and after low-temperature regeneration at 150° C., the catalytic activity can be well recovered.

The gas purification method provided in the third aspect of the present disclosure can maintain an O₃ removal rate of 90% or more for 2000 minutes, and is suitable for ozone purification comprising low-temperature and high-flow-rate aircraft cabin ozone removal, factory ozone exhaust treatment, indoor ozone purification, etc. In other words, the modified zeolite catalyst plays a crucial role during the catalytic decomposition process of ozone, and improves the low-temperature catalytic oxidation efficiency of O₃. In other words, the modified zeolite catalyst plays a crucial role during the catalytic decomposition process of ozone, and improves the low-temperature catalytic oxidation efficiency of O₃.

### BRIEF DESCRIPTION OF DRAWINGS

FIG. 1 is a schematic diagram showing the test results of the ozone conversion performance of zeolite catalysts (D1-Mn-FAU and D2-Mn-FAU) prepared by a preparation method for a modified zeolite catalyst in an example of the present disclosure and catalysts (T1-Mn-FAU and T2-Mn-FAU) prepared by the existing conventional liquid-phase modification method at an ozone concentration of 20 ppm, room temperature, and a flow rate of 1.0 L·min⁻¹.

FIG. 2 is a regeneration performance test curve graph of a zeolite catalyst D2-Mn-FAU prepared by a preparation method for a modified zeolite catalyst in an example of the present disclosure at an ozone concentration of 20 ppm, room temperature, and a flow rate of 1.0 L·min⁻¹.

FIG. 3 is a schematic diagram comparing the XRD (X-ray diffraction) characterization results of zeolite catalysts (D1-Mn-FAU and D2-Mn-FAU) prepared by a preparation method for a modified zeolite catalyst in an example of the present disclosure and the raw zeolite powder (FAU zeolite).

FIG. 4 is a schematic diagram of an efficiency curve of zeolite catalysts, i.e., a single metal cluster catalyst (D1-Mn-FAU) and a multi-metal cluster catalyst (D1-Mn₂Cu-FAU) which are obtained by preparation methods in the examples of the present disclosure at an ozone concentration of 20 ppm, room temperature, and a flow rate of 1.0 L·min⁻¹.

FIG. 5 is a schematic diagram of polyatomic metal clusters located in a zeolite framework structure of a zeolite catalyst prepared by a preparation method for a modified zeolite catalyst in an example of the present disclosure.

FIG. 6 is a schematic diagram showing the results of calculating the reaction energy and transition state energy barrier of modified catalysts prepared by a preparation method in an example of the present disclosure by using a CASTEP module (plane-wave pseudopotential method) in Materials studio (material simulation computation software).

### DETAILED DESCRIPTION OF THE INVENTION

In order to make the objects, technical solutions and advantages of the present disclosure more clear, the present disclosure will be further described below in detail with reference to the accompanying drawings and the examples. It should be understood that the specific examples described herein are merely illustrative of the present disclosure and are not intended to limit the present disclosure.

On the contrary, the present disclosure is intended to cover any replacements, modifications, equivalents, and solutions as defined by the appended claims within the spirit and scope of the present disclosure. Further, in order to provide the public with a better understanding of the present disclosure, in the following detailed description of the present disclosure, some specific details are described in detail. The present disclosure may be fully understood by those skilled in the art without these detailed descriptions.

The following examples serve to illustrate the present disclosure. In the examples, unless otherwise indicated, parts are parts by weight, percentages are percentages by weight, and temperatures are in degrees Celsius. A relationship between fractions by weight and parts by volume is the same as a relationship between grams and cubic centimeters.

A full English name of the term “MFI” is “Mobil Five”, and MFI and FAU are both a type of zeolite topological structure.

In a first aspect of an example of the present disclosure, provided is a preparation method for a modified zeolite catalyst, wherein the preparation method adjusts metal clusters in a framework of a modified zeolite, and comprises mixing a metal salt solution with a zeolite to form a non-Newtonian fluid mixture, drying the mixture by using microwaves, and finally performing calcining to obtain the modified zeolite catalyst.

The preparation method for the modified zeolite catalyst provided in the first aspect of the example of the present disclosure comprises mixing the metal salt solution with the zeolite to form the non-Newtonian fluid mixture, drying the mixture by using microwaves, and finally performing calcining to obtain the modified zeolite catalyst. The preparation method adjusts the metal clusters in the framework of the modified zeolite, the amount of the metal salt used is calculated based on the silica-alumina ratio and the theoretical degree of ion exchange, and the amount of water used in the metal salt solution is calculated based on a target exchange state, so that a polymer formed by a metal cation and a water molecule is uniformly distributed in pore channels of the zeolite, and the degree of metal ion exchange can be adjusted and controlled. In the preparation method, the microwaves are used to dry the mixture of the metal salt solution and the zeolite, the drying time is short, and the evaporation of water is quick, thereby maintaining the state of metal cations in a zeolite framework, and preventing catalyst particles (metal clusters) from being deintercalated from the zeolite framework and becoming aggregated. In addition, the preparation method adopts a simple process of mixing and stirring, avoiding a long-term heating and stirring process. The catalyst preparation time is greatly reduced, thereby reducing the energy consumption of the catalyst preparation process.

In some examples of the present disclosure, provided is a preparation method for a modified zeolite catalyst, comprising the steps of:
S1, separately preparing the metal salt solution and the zeolite in a specified ratio;
S2, preparing the non-Newtonian fluid mixture: mixing and stirring the metal salt solution prepared in S1 and the zeolite prepared in S1 to obtain the non-Newtonian fluid mixture;
S3, microwave drying the non-Newtonian fluid mixture; and
S4, calcining the dried non-Newtonian fluid mixture to obtain the modified zeolite catalyst.

In some examples of the present disclosure, in the above step S1, preparing the metal salt solution specifically comprises:
S1.1, determining the amount of metal salt used: the mass of the metal salt is calculated based on the silica-alumina ratio and the theoretical degree of ion exchange; the amount of the metal salt added is calculated from the silica-alumina ratio and the theoretical degree of ion exchange of the zeolite; the silica-alumina ratio of the zeolite is any number greater than 1, the target exchange state is a metal cluster with 1-5 metal ions; and the metal salt is used in a small amount, has low cost, does not produce a waste liquid, and is environmentally friendly.
S1.2, determining the amount of water required in the metal salt solution: deionized water is added dropwise to the zeolite of which the amount is the same as that in S2 while uniform stirring so that the obtained mixture is in a non-Newtonian fluid state; and at this time, the amount of the deionized water added is the amount of the water required to prepare the metal salt solution;
S1.3, the metal salt in S1.1 is mixed with the water in S1.2 to obtain the metal salt solution. The calculated metal salt solution is mixed with the zeolite, which not only ensures the metal ion loading amount of the zeolite, but also realizes the adjustable and controllable degree of ion exchange. The type and polymerization state of metal ions in the pore channels of the zeolite are determined by the calculated amount.

In some examples of the present disclosure, the step S2 specifically comprises adding the prepared metal salt solution dropwise to the zeolite while uniformly stirring so that the mixture is in a non-Newtonian fluid state; the purpose of this operation is to allow metal salt ions to form a charged ionic polymer with water to be uniformly distributed in the pore channels of the zeolite.

In some examples of the present disclosure, taking single metal cation exchange and nitrate as an example, the usage amount of the metal salt required is calculated as follows:

The molecular formula of a zeolite molecular sieve used is H(AlO₂)(SiO₂)ₙ, n being any number not less than 1; and a theoretical exchanged metal cluster is [MₓO_{y}]^{z+}, wherein M is a metal, 0<x≤5, 0≤y≤5, z>0, and x, y and z are all integers;

Modifying 1 mol of the zeolite molecular sieve requires (x/z) mol of metal cations, and (x/z) mol of the nitrate (or (x/z) mol of acetate); and

The mass of the nitrate is calculated based on the molar mass of the zeolite molecular sieve and the nitrate.

In some examples of the present disclosure, a molar ratio of the metal salt to the zeolite is in the range of greater than 0 to 5.

In some examples of the present disclosure, the metal salt is nitrate and/or acetate. Both types of salts are easily soluble in water, and metals dissolved in water in the metal salt solution are free metal ions, facilitating subsequent ion exchange.

In some examples of the present disclosure, the nitrate comprises nitrates of manganese, cobalt, copper, cerium, tin, lanthanum, praseodymium, samarium, europium, gadolinium, potassium, calcium, zinc, magnesium, and nickel.

In some examples of the present disclosure, the acetate comprises acetates of manganese, cobalt, copper, cerium, tin, lanthanum, praseodymium, samarium, europium, gadolinium, potassium, calcium, zinc, magnesium, and nickel.

In some examples of the present disclosure, the metal salt solution is in a saturation concentration range.

In some examples of the present disclosure, in the above step S3, microwave drying the non-Newtonian fluid mixture specifically comprises:

the non-Newtonian fluid mixture is evenly spread into a crucible or an evaporating dish or a stainless steel beaker and then rapidly heated with a microwave reactor at a power of 100-1000 W for 30 s-30 min.

Water in the mixture is rapidly evaporated during microwave heating, and a polymer of metal salt ions is locked in the pore channels of the zeolite to prevent the polymer from adhering to the surface of the zeolite due to evaporation of the water; and at this time, 1-5 initial clusters are uniformly distributed in the pore channels of the zeolite powder, the initial clusters comprising metal ions and nitrate ions. The water is rapidly evaporated by microwave drying under the condition of high temperature and high pressure to lock the polymer of the metal salt ions in the pore channels of the zeolite, preventing the metal ions from moving with the water molecule, and preserving the polymerization state and position of the metal ions. A specific number of metal polymers have higher catalytic activity and can improve the low-temperature ozone conversion performance of the zeolite catalyst.

In some examples of the present disclosure, in the above step S4, calcining the dried non-Newtonian fluid mixture specifically comprises:
the dried powder is calcined by using an oven, a hot plate, a heating mantle, a muffle furnace or a tube furnace at a temperature of 300-1200° C. for 1-12 h; calcination can remove nitrate ions (a product obtained after ion exchange of nitrate with H in the zeolite is HNO₃, which is removed by decomposition during calcination) and the remaining water molecules in the pore channels of the zeolite to obtain metal clusters formed by metal ions and adapted oxygen atoms; and the zeolite catalyst powder obtained after calcination has a very high catalytic activity.

In a second aspect of an example of the present disclosure, provided is a modified zeolite catalyst, prepared by the preparation method for the modified zeolite catalyst described above, wherein a plurality of metal clusters are uniformly distributed in the pore channels of the zeolite powder; and the metal clusters comprise metal ions and adapted oxygen atoms; and
at least one metal ion is provided; and preferably, the number of the metal ions is 1-5.

In a second aspect of an example of the present disclosure, provided is a modified zeolite catalyst, having a plurality of clusters composed of metal cations as catalytical active components, the clusters being uniformly distributed. Compared with the traditional modified zeolite catalyst with single cation exchange, the metal clusters of the zeolite catalyst have a higher catalytic activity, play a crucial role in the catalytic decomposition process of ozone (O₃), and improve the low-temperature O₃ catalytic oxidation efficiency of the catalyst. The zeolite catalyst has excellent low-temperature catalytic activity and stability and can maintain an O₃ removal rate of 90% or more for 2000 minutes at room temperature and a flow rate of 1.0 L·min⁻¹. In addition, the catalyst has excellent regeneration properties, and after low-temperature regeneration at 150° C., the catalytic activity can be well recovered.

In a third aspect of an example of the present disclosure, provided is an gas purification method, using the zeolite catalyst described above to purify ozone. The zeolite catalyst removes ozone at a space velocity of 1×10⁴ h⁻¹-2×10⁶ h⁻¹ at −10° C. to 300° C., and maintains an O₃ removal rate of 90% or more for 2000 minutes.

The gas purification method provided in the third aspect of the example of the present disclosure can maintain an O₃ removal rate of 90% or more for 2000 minutes, and is suitable for ozone purification including low-temperature and high-flow-rate aircraft cabin ozone removal, factory ozone exhaust treatment, indoor ozone purification, etc.

In some examples of the present disclosure, the zeolite catalyst maintains an O₃ removal rate of 90% or more for 2000 minutes at room temperature and a flow rate of 1.0 L·min⁻¹.

In some examples of the present disclosure, a range of ozone purification comprises low-temperature and high-flow-rate aircraft cabin ozone removal, factory ozone exhaust treatment, and indoor ozone purification.

In some examples of the present disclosure, the form of the zeolite catalyst comprises, but is not limited to, a powder catalyst, a granular catalyst (prepared after mixing with a binder), and a monolithic catalyst (extruded or coated).

Hereinafter, the technical solution of the present disclosure will be further described with reference to the examples.

### Example 1

A preparation method for a modified zeolite catalyst comprised the following steps:
(1) an FAU zeolite and a 50 wt % manganese nitrate solution were measured;
(2) determining the amount of water required for modification: 10 g of the zeolite was weighed, deionized water was added dropwise to the zeolite powder while uniformly stirring until the mixture was in a non-Newtonian fluid state, and at this time, 10.0 ml of deionized water was added, and the amount of water required was recorded.
(3) calculating the amount of the zeolite used and the amount of the manganese nitrate solution used: the amount of the zeolite used and the amount of the manganese nitrate solution used were calculated based on a silica-alumina ratio and a theoretical degree of ion exchange of the zeolite used, and 10 g of the zeolite was weighed, and 4.26 g of the 50 wt % manganese nitrate solution was weighed to be prepared into 10 ml of a solution.
(4) The prepared manganese nitrate solution was added dropwise to the zeolite powder while uniformly stirring so that the obtained mixture was in a non-Newtonian fluid state.
(5) The mixture was spread evenly into an evaporating dish and rapidly dried with a microwave reactor at a power of 800 W for 4 minutes.
(6) The dried powder was calcined using a muffle furnace at a temperature of 350° C. for 3 h at a heating rate of 2° C./min to obtain a modified zeolite catalyst powder.

### Example 2

Provided was a preparation method for a modified zeolite catalyst. The preparation method for the modified zeolite catalyst in this example was basically the same as that in Example 1, except that the theoretical degree of ion exchange of metal ions in this example was 3.0 and the theoretically exchanged metal cluster was [Mn₃O₃]²⁺.

### Example 3

Provided was a preparation method for a modified zeolite catalyst. The preparation method for the modified zeolite catalyst in this example was basically the same as that in Example 1, except that the zeolite powder used was tZSM-5 having a topological structure of MFI.

### Example 4

Provided was a preparation method for a modified zeolite catalyst. The preparation method for the modified zeolite catalyst in this example was basically the same as that in Example 1, except that a drying power of the microwave reactor was 600 W and the drying time was 8 minutes.

### Example 5

Provided was a preparation method for a modified zeolite catalyst. The preparation method for the modified zeolite catalyst in this example was basically the same as that in Example 1, except that the mixture was charged into an oven to be dried at a temperature of 160° C. for 2 h.

### Example 6

Provided was a preparation method for a modified zeolite catalyst. The preparation method for the modified zeolite catalyst in this example was basically the same as that in Example 1, except that the dried powder was calcined by using a muffle furnace at a temperature of 450° C. for 3 h.

### Example 7

Provided was a preparation method for a modified zeolite catalyst. The preparation method for the modified zeolite catalyst in this example was basically the same as that in Example 1, except that a theoretically exchanged cluster was [Mn₂CuO₃]²⁺.

### Example 8

Provided was a preparation method for a modified zeolite catalyst. The preparation method for the modified zeolite catalyst in this example was basically the same as that in Example 1, except that:
the preparation method further included a step (7): the zeolite catalyst powder was ground, the resulting zeolite fine powder, a binder, an auxiliary agent, and deionized water were uniformly mixed in a certain ratio to form a spherical or cylindrical shape, and drying and calcining were performed to obtain a granular zeolite catalyst.

### Example 9

Provided was a preparation method for a modified zeolite catalyst. The preparation method for the modified zeolite catalyst in this example was basically the same as that in Example 1, except that:
the preparation method further included a step (7): the zeolite catalyst powder was ground, the resulting zeolite fine powder, a binder, an auxiliary agent, and deionized water were uniformly mixed in a certain ratio, the obtained mixture was extruded into a honeycomb shape under a certain pressure using a mold, and drying and calcining were performed to obtain an extruded honeycomb zeolite catalyst.

### Example 10

Provided was a preparation method for a modified zeolite catalyst. The preparation method for the modified zeolite catalyst in this example was basically the same as that in Example 1, except that:
the preparation method further included a step (7): the zeolite catalyst powder was ground, the resulting zeolite fine powder, a binder, an auxiliary agent, and deionized water were uniformly mixed in a certain ratio to prepare a slurry having a suitable viscosity, and a support prepared in advance was impregnated in the slurry for 10 s-30 min, taken out, dried, and calcined to obtain a coated monolithic catalyst. The support comprises a metal support, a cordierite support, and a glass or ceramic fiber support.

### Comparative Example 1

Catalyst samples (T1-Mn-FAU and T2-Mn-FAU) obtained by using a salt solution stirring impregnation method (the existing conventional liquid phase modification method).

Next, the modified zeolite catalysts prepared in Examples 1-10 and the catalyst samples in Comparative example 1 were analyzed.

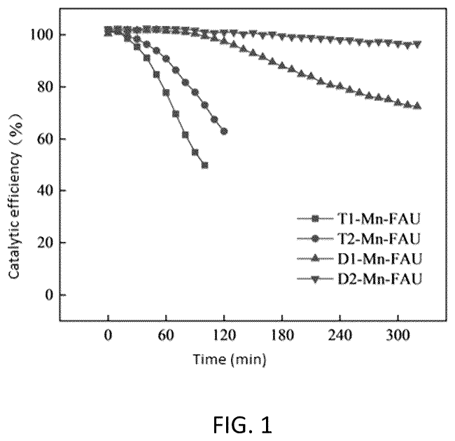

As shown in FIG. 1, a schematic diagram showing the test results of the ozone conversion performance of the catalyst samples (T1-Mn-FAU and T2-Mn-FAU) obtained by the salt solution stirring impregnation method (the existing conventional liquid phase modification method) in Comparative example 1 and the zeolite catalysts (D1-Mn-FAU and D2-Mn-FAU) obtained by the preparation method in Example 1 at an ozone concentration of 20 ppm, room temperature, and a flow rate of 1.0 L·min⁻¹ is shown. As can be seen from FIG. 1, the modified sample was tableted by a tablet press, and then ground into crushed particles, and a granular catalyst of 40-60 mesh was screened out by a screen; 30-1000 mg of the granular catalyst was filled into a reactor; the ozone concentration at an inlet of the reactor was kept at 20 ppm, the ozone concentration C of gas at an outlet of the reactor was monitored and recorded in real time, and an ozone conversion efficiency curve was plotted with time as an x-axis and 1-C/20 as a y-axis, as shown in the figure. By comparing the ozone purification efficiency of the zeolite catalysts obtained by different methods (the salt solution stirring impregnation method and a DT method), it can be seen that the samples obtained by the salt solution stirring impregnation method deactivate rapidly after being tested for a period of time, and has much lower catalytic activity than D1-Mn-FAU and D2-Mn-FAU.

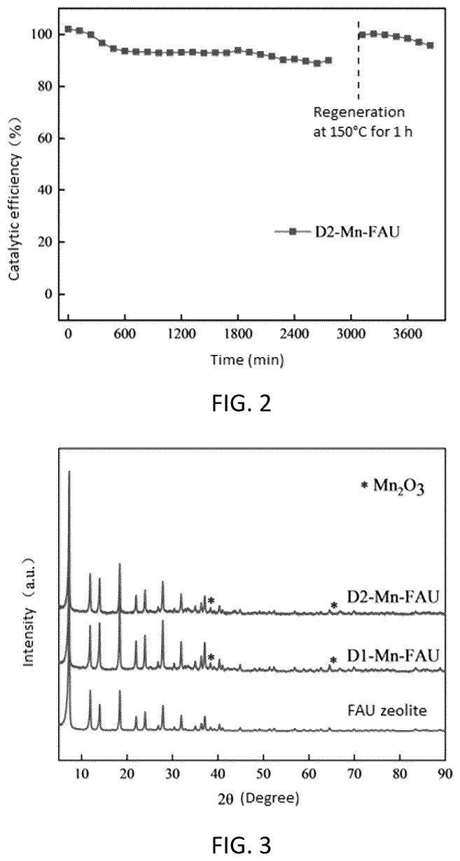

As shown in FIG. 2, a regeneration performance test curve graph of the zeolite catalyst D2-Mn-FAU prepared by the preparation method for the modified zeolite catalyst in Example 1 at an ozone concentration of 20 ppm, room temperature and a flow rate of 1.0 L·min⁻¹ is shown. As can be seen from FIG. 2, the modified zeolite material can be regenerated under the heating condition of 150° C., and the catalytic activity can be well restored.

As shown in FIG. 3, a schematic diagram comparing the XRD characterization results of the zeolite catalysts (D1-Mn-FAU and D2-Mn-FAU) prepared by the preparation method for the modified zeolite catalyst in Example 1 of the present disclosure and raw zeolite powder (FAU zeolite) is shown. As can be seen from FIG. 3, there is no obvious difference between XRD curves of the samples before and after modification, and the modification process does not destroy the skeleton structure of the zeolite.

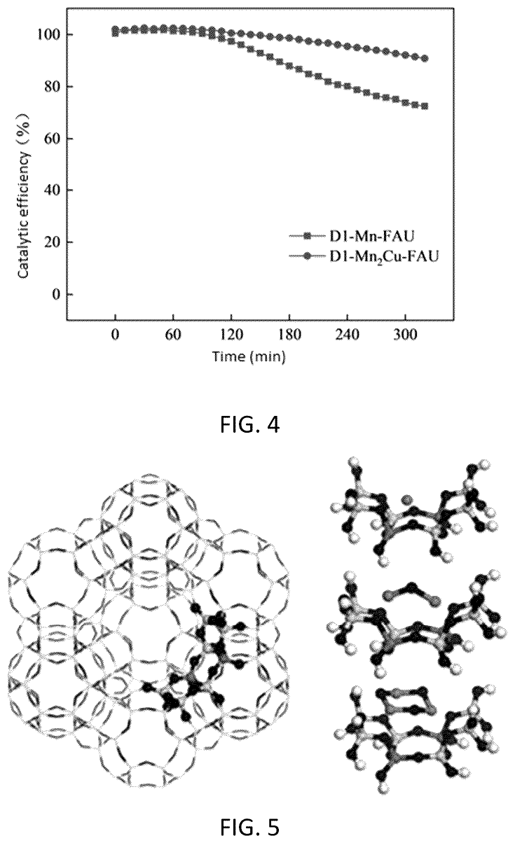

As shown in FIG. 4, the test results of the ozone conversion performance of a single metal cluster catalyst (D1-Mn-FAU) and a multi-metal cluster catalyst (D1-Mn2Cu-FAU) which were separately prepared by the preparation method for the modified zeolite catalyst in Example 1 and Example 7 at an ozone concentration of 20 ppm, room temperature, and a flow rate of 1.0 L·min⁻¹ are shown. As can be seen from FIG. 4, the synergistic effects between various elements in the catalyst can improve its catalytic performance.

As shown in FIG. 5, a schematic diagram of polyatomic metal clusters located in a zeolite framework structure of the zeolite catalyst prepared by the preparation method in Example 2 is shown. As can be seen from FIG. 5, in the zeolite framework structure, [AlO₂]⁻ with a negative charge can attract each other to ion clusters composed of metal ions and oxygen atoms, and becomes a location site for the metal clusters.

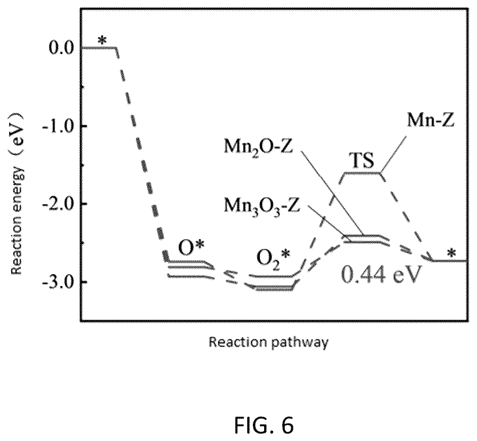

Referring to FIG. 6, a schematic diagram showing the results of calculating the reaction energy and transition state energy barrier of the modified zeolite catalysts prepared in Example 1 and Example 2 by using a CASTEP module (plane-wave pseudopotential method) in Materials studio (material simulation computation software) is shown. As can be seen from FIG. 6, in zeolite catalyst models exchanged by different metal ion clusters (Mn²⁺, Mn₂O²⁺, and Mn₃O₃²⁺), the adsorption energy of ozone molecules increases with the increase of the number of Mn atoms, and the transition state energy barrier in the reaction rate-limiting step decreases with the increase of the number of Mn atoms. The metal cluster model composed of three Mn atoms in the pore channels of the zeolite has higher ozone adsorption energy and lower energy barrier in the rate-controlling step, and thus has higher catalytic activity than single-atom catalytically active sites.

The above are only preferred examples of the present disclosure and are not intended to limit the present disclosure, and any modifications, equivalent substitutions, improvements, and the like within the spirit and principle of the present disclosure should be included within the protection scope of the present disclosure.

What is claimed is:

1. A preparation method for a modified zeolite catalyst, wherein the preparation method adjusts metal clusters in a framework of a modified zeolite, and preparation method comprises mixing a metal salt solution with a zeolite to form a non-Newtonian fluid mixture, drying the non-Newtonian fluid mixture by using microwaves, and finally performing calcining to obtain the modified zeolite catalyst.

2. The preparation method for the modified zeolite catalyst according to claim 1, wherein the preparation method specifically comprises steps of:
separately preparing the metal salt solution and the zeolite in a specified ratio;
preparing the non-Newtonian fluid mixture by mixing and stirring the metal salt solution and the zeolite to obtain the non-Newtonian fluid mixture;
microwave drying the non-Newtonian fluid mixture to obtain a dried non-Newtonian fluid mixture; and
calcining the dried non-Newtonian fluid mixture to obtain the modified zeolite catalyst.

3. The preparation method for the modified zeolite catalyst according to claim 2, wherein preparing the metal salt solution specifically comprises:
determining an amount of a metal salt used by calculating a mass of the metal salt based on a silica-alumina ratio and a theoretical degree of ion exchange;
determining an amount of water required to prepare the metal salt solution by adding deionized water dropwise to an equivalent amount of the zeolite, and performing uniform stirring until an obtained mixture is in a non-Newtonian fluid state, wherein an amount of the deionized water added dropwise is the amount of the water required to prepare the metal salt solution; and
mixing the metal salt with the amount of the water required to obtain the metal salt solution.

4. The preparation method for the modified zeolite catalyst according to claim 3, wherein a molar ratio of the metal salt to the zeolite is in a range of greater than 0 to 5.

5. The preparation method for the modified zeolite catalyst according to claim 3, wherein the metal salt comprises at least one of nitrate or acetate.

6. The preparation method for the modified zeolite catalyst according to claim 2, wherein microwave drying the non-Newtonian fluid mixture specifically comprises:
evenly spreading the non-Newtonian fluid mixture into a crucible, an evaporating dish or a stainless steel beaker, and heating the non-Newtonian fluid mixture with a microwave reactor at a power of 100-1000 W for 30 s-30 min.

7. The preparation method for the modified zeolite catalyst according to claim 2, wherein the metal clusters comprise one or more metal clusters of Mn²⁺, Mn₂O²⁺, Mn₃O₃²⁺, [AlO₂]⁺, [MnCuO]²⁺, [Mn₂CuO₃]²⁺, or [FeCoO]²⁺.

8. A modified zeolite catalyst, prepared by the preparation method according to claim 1, wherein a plurality of the metal clusters are uniformly distributed in pore channels of a zeolite powder in the modified zeolite catalyst;
the metal clusters comprise metal ions and adapted oxygen atoms; and
at least one metal ion is present.

9. A gas purification method, using the modified zeolite catalyst according to claim 8 to purify ozone, wherein
the modified zeolite catalyst removes the ozone at a space velocity of 1×10⁴ h⁻¹-2×10⁶ h⁻¹ at −10° C. to 300° C.

10. The gas purification method according to claim 9, wherein a form of the modified zeolite catalyst comprises at least one of a powder catalyst, a granular catalyst, and a monolithic catalyst.

11. A modified zeolite catalyst, prepared by the preparation method according to claim 2, wherein a plurality of the metal clusters are uniformly distributed in pore channels of a zeolite powder in the modified zeolite catalyst;
the metal clusters comprise metal ions and adapted oxygen atoms; and
at least one metal ion is present.

12. A gas purification method, using the modified zeolite catalyst according to claim 11 to purify ozone, wherein
the modified zeolite catalyst removes the ozone at a space velocity of 1×10⁴ h⁻¹-2×10⁶ h⁻¹ at −10° C. to 300° C.

13. The gas purification method according to claim 12, wherein a form of the modified zeolite catalyst comprises at least one of a powder catalyst, a granular catalyst, and a monolithic catalyst.

14. A modified zeolite catalyst, prepared by the preparation method according to claim 3, wherein a plurality of the metal clusters are uniformly distributed in pore channels of a zeolite powder in the modified zeolite catalyst;
the metal clusters comprise metal ions and adapted oxygen atoms; and
at least one metal ion is present.

15. A gas purification method, using the modified zeolite catalyst according to claim 14 to purify ozone, wherein
the modified zeolite catalyst removes the ozone at a space velocity of 1×10⁴ h⁻¹-2×10⁶ h⁻¹ at −10° C. to 300° C.

16. The gas purification method according to claim 15, wherein a form of the modified zeolite catalyst comprises at least one of a powder catalyst, a granular catalyst, and a monolithic catalyst.

17. A modified zeolite catalyst, prepared by the preparation method according to claim 4, wherein a plurality of the metal clusters are uniformly distributed in pore channels of a zeolite powder in the modified zeolite catalyst;
the metal clusters comprise metal ions and adapted oxygen atoms; and
at least one metal ion is present.

18. A modified zeolite catalyst, prepared by the preparation method according to claim 5, wherein a plurality of the metal clusters are uniformly distributed in pore channels of a zeolite powder in the modified zeolite catalyst;
the metal clusters comprise metal ions and adapted oxygen atoms; and
at least one metal ion is present.

19. A modified zeolite catalyst, prepared by the preparation method according to claim 6, wherein a plurality of the metal clusters are uniformly distributed in pore channels of a zeolite powder in the modified zeolite catalyst;
the metal clusters comprise metal ions and adapted oxygen atoms; and
at least one metal ion is present.

20. A modified zeolite catalyst, prepared by the preparation method according to claim 7, wherein a plurality of the metal clusters are uniformly distributed in pore channels of a zeolite powder in the modified zeolite catalyst;
the metal clusters comprise metal ions and adapted oxygen atoms; and
at least one metal ion is present.
